(19) United States
(12) Patent Application Publication
(10) Pub. No.: US 2025/0278684 A1
(43) Pub. Date: Sep. 4, 2025

(54) System of interlinked software modules to receive product requirements and create product development plans and timelines with resource monitoring displaced in visual dashboards with software algorithms and AI tools for continuous and real-time monitoring of product development and regulatory submissions

(71) Applicant: Fayyaz Memon, Bethesda, MD (US)

(72) Inventor: Fayyaz Memon, Bethesda, MD (US)

(21) Appl. No.: 18/620,010

(22) Filed: Mar. 28, 2024

Related U.S. Application Data
(60) Provisional application No. 63/492,810, filed on Mar. 29, 2023.

(51) Int. Cl. G06Q 10/0631; G06Q 30/018

(52) U.S. Cl. CPC G06Q 10/06313; G06Q 10/0637; G06Q 10/06375; G06Q 30/018

(57) ABSTRACT

This invention is a system of interlinked software modules to generate product requirements and create and monitor product development plans with resources and timelines with an integrated product development and management process to convert design requirements into design deliverables. The software and system connect product development with project management process to create and monitor timelines and resources to ensure that the product is developed according to the requirements. The system also monitors the process on a continuous basis and reminds the assigned and responsible parties about the assigned tasks and any changes and delays are communicated to responsible parties. The system also has the capability to analyze project risks and make assessment in real time. This approach also helps to reduce the cycle time to develop products efficiently by linking external regulatory resources and to plan and develop regulatory documentations for submissions and meet regulatory milestones for commercial goals.

### BACKGROUND OF THE INVENTION

There are several software packages with functionality to duplicate paper systems for developing design control/product development documents in electronic documents and workflows. These systems primarily convert the paper documents and workflows into electronic documents. The documents that are converted into PDF or some other formats as a part of design control/product development history for future FDA submissions, quality audits, or technical files. Program/Project management roles primarily manually follows if these documents are developed and approved. Most organizations hire multiple headcounts and deploy several resources to track and monitor progress through excel sheets without any real time monitoring and tracking. Additionally, any changes made in the requirements are manually propagated by updating several documents, which results in significant delays and errors. This not only costs significant resources for the organization but also contributes to significant delays in timelines and lack of proper visibility.

This invention collects, correlates, processes, and analyzes inputs from multiple sources into a single platform to provide coordinated program management and a streamlined, and efficient approach to product development for medical and diagnostic devices with tracking, monitoring, and automated follow-up on the activities and updating and at the same time developing documentation as per regulatory requirements. This invention will reduce the resources required to maintain project/program management and documentation as well as provide clear visibility of timelines through real time monitoring dashboard. This invention will also enable the organization to make changes with impact assessment and communication is real time to reduce project and product development timelines.

### DETAILED DESCRIPTION OF THE INVENTION

There are several software packages available that claim to have an electronic quality system (eQMS) including electronic design control documentation. These packages, however, primarily work by either converting paper workflow into electronic workflows or linking with guidance and templates to create regulatory documents for design or product development. Developing a product is a comprehensive activity to be managed as a project which includes regulatory submissions, execution of tasks associated with product development, and project monitoring. Traditionally, these activities are managed separately with different tools. The purpose of this invention to integrate and automate project management and product development including regulatory documentation, to create a concise and clear real time dashboard to manage resources and timelines to bring products effectively and efficiently to marketplace.

This software and system invention links and consolidates inputs from various sources to develop, track, and monitor activities from various stakeholders, components, and databases to produce status report, dashboards, action items, and activities.

### DESCRIPTION OF DRAWINGS

FIG. 1: is the initial landing page for project Set-up and requirements. This is used to set-up a project, update the project, view the project, and view the dashboard.

FIG. 2: is used to collect and generate business and marketing requirements.

FIG. 3: is used to collect and generate user requirements.

FIG. 4: is used to collect and generate regulatory requirement.

FIG. 5: is used to generate product requirements based on the high level requirement.

FIG. 6: is used to generate requirements traceability matrix and linking design input to deign outputs.

FIG. 7: is used to generate product development plans with timelines and resources based on deliverables.

FIG. 8: is used to perform product and project updates and changes, view specific project, and or view dashboard linked with FIG. 1.

### RELATIONSHIP BETWEEN COMPONENTS

### Creation of Project/Products

User will initiate the log-in process on the landing page. Username and password will be required to create a project. Username and password will be verified and validated via “Active Directory” or the user will be asked to create a user profile and account. This landing page will have four major options:
1. Create a new project
2. Update a project
3. View projects
4. View Dashboard

If the user is established and if there are any project action items or news, these will display as well. A project can only be viewed and updated if it has been created.

### Creation of Requirements

After a project has been established with required information, then project requirements will be created with any associated timelines (if available). The timelines are not required at this stage, but the user will be prompted at a later stage after requirements have been created. There are multiple types of requirements depending on the product and projects.

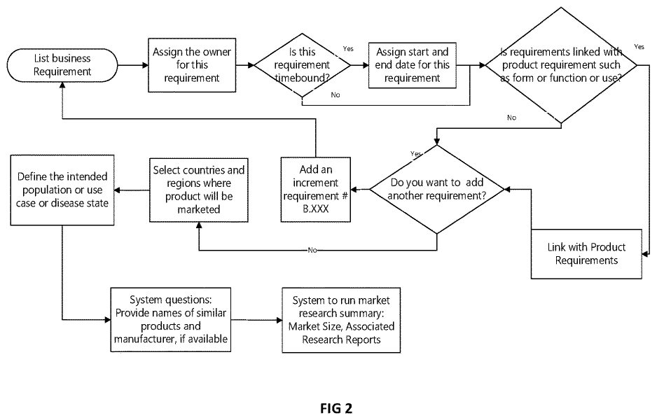

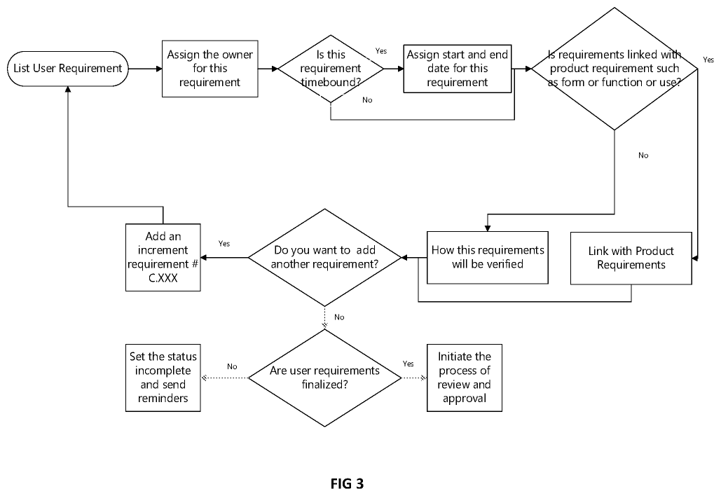

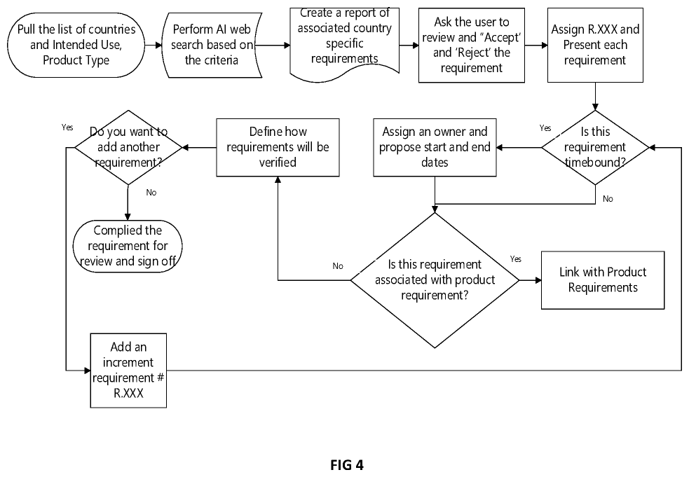

The system will prompt the user to create the requirements by providing guidance throughout the process. Creation of Business Requirements will be created using FIG. 2. User Requirements will be created using FIG. 3. Regulatory Requirements will be created using FIG. 4.

### Creation of Product Requirements

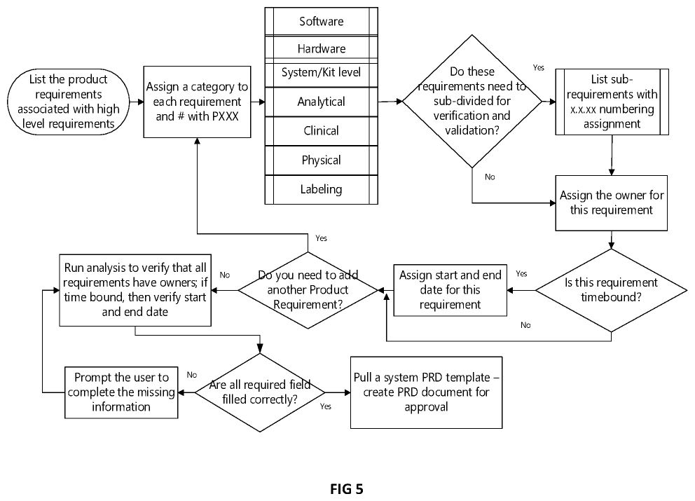

high level business, user, and regulatory requirements have been created, the next step is to create product requirements that define the details of product design. The product requirements are linked with the high-level requirements and are presented to the user to be identified into categories as physical, software, hardware, analytical, clinical, labeling, performance, etc. The user is then prompted if each requirement needs to be divided into sub-categories for verification and validation. The process in FIG. 5 is used to generate product requirements.

### Creation of Traceability Matrix (Linking Input to Output)

After requirements have been established, the user will be prompted to define specific deliverables linked with the requirements. These are also called “Design Outputs”. These could be a product, specification, device master record, drawing, label, user manual, test reports, clinical report, or other types of deliverables. The user will be prompted to define specific deliverables linked to specific regulatory submissions or design history records or device master records. The user will have the option to define deliverables (output) during the deign requirement stage or after the creation of traceability stage.

### Project Development

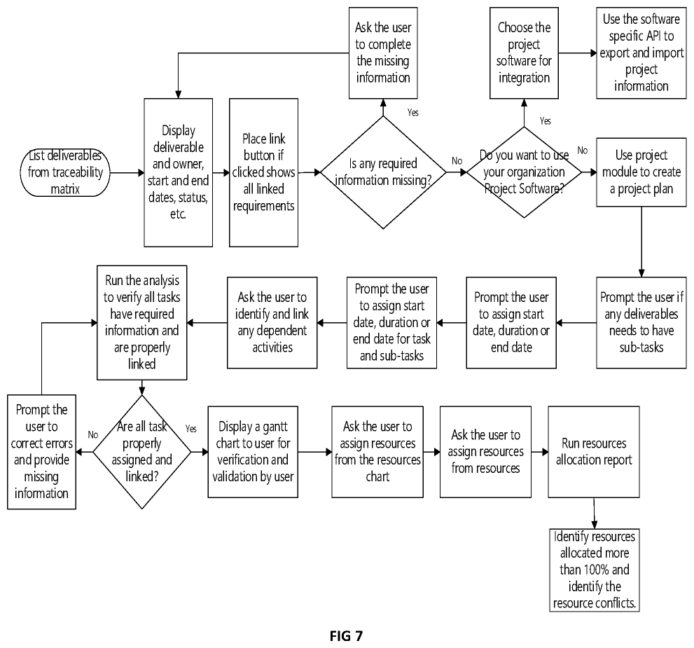

The project development process is initiated after deliverables have been defined. This will lay out the basis for the project plan with specific timelines and resources as per FIG. 7. The following questions will be addressed: What will be done? When will it be done? Who will do it? This phase will also define the interconnected and dependent activities. After project planning is in place, project monitoring will be initiated. The system will run the status reports on a daily or weekly basis and send notifications to owners to update the activities and tasks based on the completion timeline and notification thresholds. The system will also run impact assessment for any delay and changes to the overall completion timelines.

### Project Update and Changes

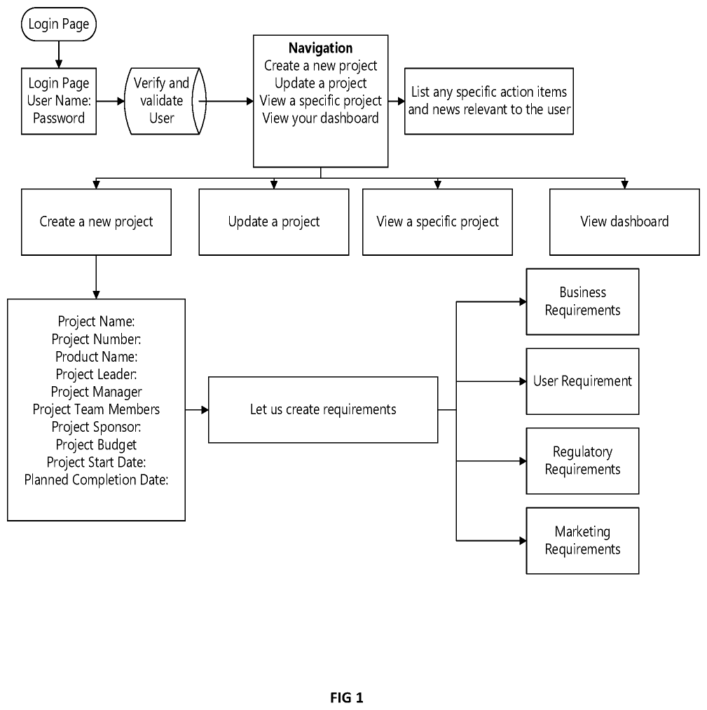

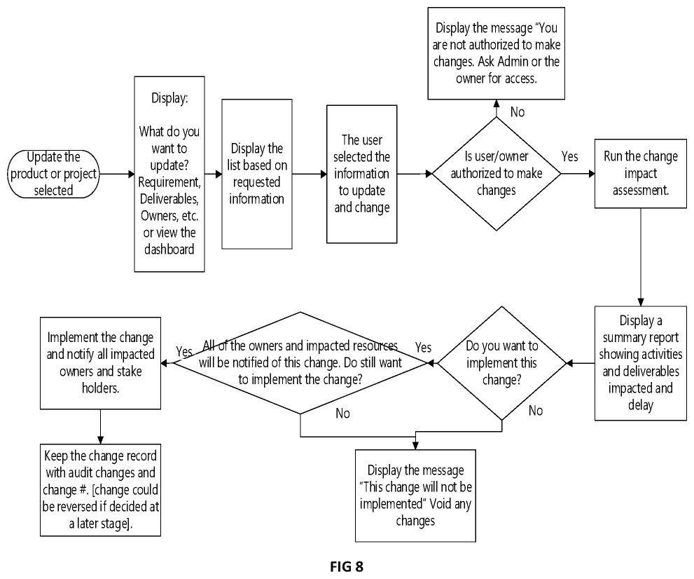

The project update and changes process are managed as per FIG. 8. The product update and change process could be initiated from the top-level navigation (FIG. 1) or by clicking on a specific activity, task, or requirements. The access to project changes is controlled using read/write access. Only authorized users with proper access and authority may make changes. After changes are made, the system will run the impact assessment and ask for verification if the user is still willing to make changes. Upon confirmation, the system will send notifications to the admin for confirmation. After confirmation, the system will update the required activity or requirement and notify all users with impact on the project plan. All changes will have an audit trail including, date and time stamp to meet the requirements of 21 CFR Part 11.

### How To Make The Invention

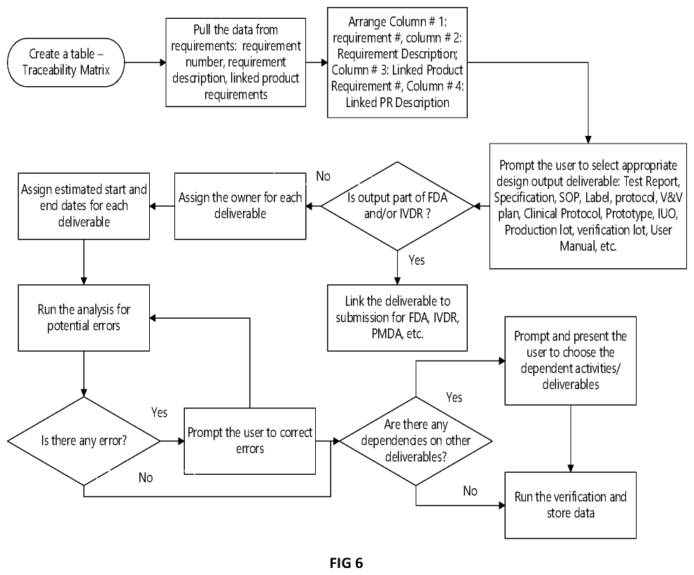

To make this invention, one must develop software and tools to collect, compile, process, analyze, and monitor inputs and output as well as the ability to store and retrieve data objects and files. The system should be able to manipulate data. The system should be able to retrieve external data through APIs and should be able to meet the regulatory requirement of 21 CFR Part 11. The system should be able to interrogate and update the data with baseline vs current data. The system should be able to identify the impact of changes and generate recommendations. The system is dynamic in nature to continuously monitor and update the knowledge database based on machine learning algorithms. The system must be able to perform the tasks listed in FIG. 1, FIG. 2, FIG. 3, FIG. 4, FIG. 5, FIG. 6, FIG. 7, and FIG. 8.

1. A method of developing and linking product requirements to project planning to generate timelines and project plans with start and end dates.

2. The method of claim 1, to create design deliverables from linked product requirements.

3. The method of claim 1, to create product requirements by providing guidance and recommendations based on regulatory requirements and market environment.

4. The method of claim 1, to create user, business, and regulatory requirements and further create product design requirements.

5. The method of claim 1, to further categorize product requirements to identify specific deliverables or design output.

6. A method of identifying and creating design deliverables from design inputs/requirements and linking with project timelines.

7. The method of creating a product traceability matrix linked with timeline to support design verification activities for medical devices and in-vitro diagnostics.

8. The method of claim 1, where any change in product and project are propagated backward and forward and assess change impact on activities and timelines.

9. The method of identifying and creating regulatory filing timelines and deliverables.
